(19) United States
(12) Patent Application Publication
(10) Pub. No.: US 2004/0135894 A1
(43) Pub. Date: Jul. 15, 2004

(54) Method, apparatus and program for image classification

(76) Inventors: Kazuo Shiota, Tokyo (JP); Kiyotaka Kaneko, Kanagawa-ken (JP)

Correspondence Address: BIRCH STEWART KOLASCH & BIRCH, PO BOX 747, FALLS CHURCH, VA, 22040-0747, US

(21) Appl. No.: 10/743,743

(22) Filed: Dec. 24, 2003

(30) Foreign Application Priority Data
Dec. 27, 2002 (JP) 2002-379060

(51) Int. Cl. H04N 5/225

(52) U.S. Cl. 348/207.99

(57) ABSTRACT

Image data sets are enabled to be classified for each of a plurality of people, who share a device that stores image data sets, such as a digital camera. Date data that represent a photography date are attached to image data sets. A database stores therein events related to each of the plurality of people, correlated with the dates of the events. The image data sets are correlated with events related to each person by referring to the database. For example, the database stores therein events related to family members (Father, Mother, and Son), correlated with the dates of the events. Accordingly, events are selected from the database based on the date data attached to the image data sets, and the image data sets are correlated with the selected events. Thereby, image data sets are enabled to be classified according to events for each person.

### BACKGROUND OF THE INVENTION

1. Field of the Invention

The present invention relates to a method and apparatus for classifying image data sets. The present invention relates also to a program that causes a computer to execute the method for classifying image data sets.

2. Description of the Related Art

Storage of image data sets obtained by digital cameras, or by scanning images recorded on negative films, is common. However, as the number of image data sets increases, organization thereof becomes troublesome. Particularly, in the case of digital cameras, a great number of image data sets are obtained because there is no charge for film. As a result, the organization of image data sets becomes extremely troublesome. For this reason, methods for automatically classifying image data have been proposed. Examples of such methods include: those in which image data sets are classified according to the medium in which they were recorded; those in which image data sets are classified according to the film from which they were obtained; and those in which image data sets are classified in hierarchical folders representing year, month, and day. U.S. Pat. No. 5,805,215 discloses a digital camera which refers to a database that manages a personal schedule, to classify image data sets according to personal events, based on date data that represents dates of photography attached to the image data sets. Users are enabled to efficiently organize image data sets by employing automatic classification methods such as those described above.

However, in the digital camera disclosed in U.S. Pat. No. 5,805,215, image data sets are classified according to personal events. Therefore, the digital camera cannot be shared with another person. That is, a database that manages a personal schedule is employed in the classification of image data sets. Accordingly, in the case that the digital camera is owned by the father of a family, classification of image data sets is only possible regarding the father's personal events. If the digital camera was shared even with family members, such as a son, image data sets can not be classified.

### SUMMARY OF THE INVENTION

The present invention has been developed in view of the above circumstances. It is an object of the present invention to enable classification of image data sets even when a device for managing image data sets, such as a digital camera, is shared among plurality of people.

The method of classifying image data sets according to the present invention is a method for classifying image data sets, to which date data that represents the date of photography are attached, comprising the steps of:

obtaining the date data from the image data sets;

selecting an event corresponding to the date of photography from a database of events, in which events that relate to each of a plurality of people are stored, correlated with dates of the events; and

correlating the image data sets with the corresponding event.

Note that the method of classifying image data sets according to the present invention may be a method wherein:

selection of a single database from among a plurality of databases is received in the case that a plurality of databases exist; and

the corresponding event is selected from events stored in the selected database.

In addition, the method of classifying image data sets according to the present invention may be a method wherein:

a plurality of corresponding events are displayed in the case that a plurality of corresponding events, correlated with dates represented by the date data, are related to the plurality of people;

selection of a single corresponding event from among the plurality of corresponding events is received; and

the image data sets are correlated to the selected corresponding event.

Here, “ . . . the case that a plurality of corresponding events . . . are related to the plurality of people . . . ” refers not only to the case in which a plurality of corresponding events exist for all of the plurality of people, but includes cases in which corresponding events exist for a portion of the plurality of people.

The image classifying apparatus according to the present invention is an image data set classifying apparatus for classifying image data sets, to which date data that represents the date of photography are attached, comprising:

a data obtaining means for obtaining the date data from the image data sets;

a storage means for storing a database of events, in which event that relate to each of a plurality of people are correlated with dates of the events;

a selecting means for selecting an event corresponding to the date of photography from the database, based on the date of photography represented by the date data; and

a correlating means for correlating the image data sets with the corresponding event selected by the selecting means.

Note that the image classifying apparatus according to the present invention may further comprise:

a database selecting means for selecting a single database from among a plurality of databases in the case that a plurality of databases exist; wherein

the selecting means selects the corresponding event from among events stored in the selected database.

In addition, the image classifying apparatus according to the present invention may further comprise:

a display means for displaying a plurality of corresponding events in the case that a plurality of corresponding events, correlated with dates represented by the date data, are related to the plurality of people; and

a selection receiving means for receiving selection of a single corresponding event from among the plurality of corresponding events; wherein

the correlating means correlates the image data sets with the selected corresponding event.

Note that the method for classifying image data sets maybe provided as a program that causes a computer to execute the method. The program may be recorded in a computer readable recording medium. A skilled artisan would know that computer readable media are not limited to any specific type of storage device and includes any kind of device, including but not limited to: CD's, floppy disks, RAM's ROM's, hard disks, magnetic tapes and internet downloads, in which computer instructions can be stored and/or transmitted. Transmission of computer code through a network or through wireless transmission means is also within the scope of the present invention. Additionally, computer code/instructions include but are not limited to source, object, and executable code. The code may be in any language, including higher level languages, assembly language, and machine language.

According to the present invention, date data are obtained from image data sets. Then, an event corresponding to the date of photography represented by the date data is selected from a database of events, in which events that relate to each of a plurality of people are stored, correlated with dates of the events. Then, the image data sets are correlated with the selected corresponding event. Therefore, image data sets can be correlated to events related to each of the plurality of people. This can be accomplished by creating a database, in which events that relate to each of a plurality of people, who share a device such as a digital camera, are stored, correlated with dates of the events. Correlation is performed by referring to the database. Accordingly, if the present invention is applied to a device such as a digital camera, image data sets can be classified according to events for each of a plurality of people, even if the device is shared among them.

In the case that there are a plurality of databases, selection of a single database from among the plurality of databases is received. Then, the corresponding event is selected by referring to the selected database. Thereby, the image data sets can be classified by referring to a database suitable for classification thereof.

In the case that there are a plurality of events, related to the plurality of people, that correspond to the date of photography represented by the date data, the plurality of corresponding events are displayed. Selection of a single event from among the plurality of displayed events is received. Then, the image data sets are correlated to the selected corresponding event. Thereby, the image data sets can be classified in a manner that reflects the intentions of the user who is classifying the image data sets.

### BRIEF DESCRIPTION OF THE DRAWINGS

FIG. 1 is a schematic block diagram illustrating the construction of a digital camera which is an image classifying apparatus according to an embodiment of the present invention.

FIG. 2 shows an example of the structure of a database stored in a memory.

FIG. 3A and FIG. 3B show an LCD monitor in a state in which names of corresponding events are displayed thereon.

FIG. 4 shows the LCD monitor in a state in which names of databases are displayed thereon.

FIG. 5 is a flow chart illustrating the procedures performed by the embodiment of the present invention.

FIG. 6 shows folders corresponding to events, in which image data sets are stored.

FIG. 7 is a schematic diagram showing the structure of an image storage system, which is an image classification apparatus according to another embodiment of the present invention.

### DESCRIPTION OF THE PREFERRED EMBODIMENTS

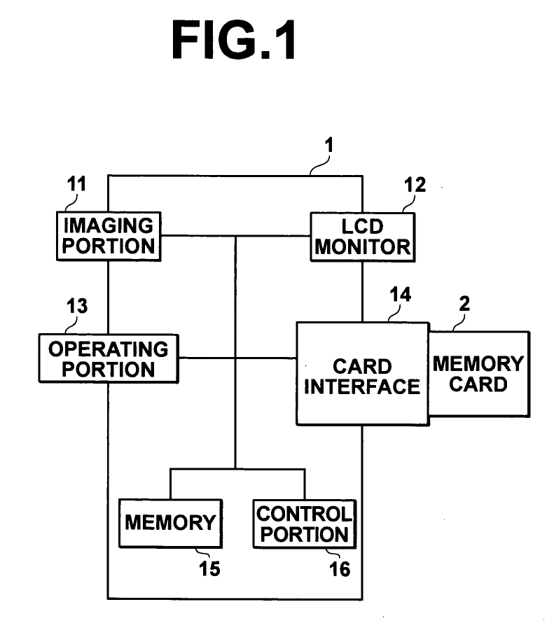

Hereinafter, embodiments of the present invention will be described with reference to the attached drawings. FIG. 1 is a schematic block diagram illustrating the construction of a digital camera 1 which is an image classifying apparatus according to an embodiment of the present invention. As shown in FIG. 1, the digital camera 1 comprises: an imaging portion 11 for obtaining image data sets S0 by photography; a liquid crystal display (LCD) monitor 12 for displaying the image data sets S0 and the like; an operating portion 13 for performing various types of input, comprising operation keys, a cruciform key and the like; a card interface 14 for mounting a memory card 2 for recording the image data sets S0 therein; a memory 15 for storing a database DB to be described later, as well as a program for classifying images; and a control portion 16 for controlling the operations of the digital camera 1, such as photography operations, display operations, and storage operation of the image data sets S0.

The imaging portion comprises: a photography lens; a zoom mechanism; a shutter; a CCD; and the like. Image data sets S0 representing images of subjects are obtained by driving the shutter to perform photography. At this time, date data, that represents the date of photography, is attached to the image data sets S0 by being written into the tag information thereof. Note that the date data may alternatively be attached to the image data sets S0 by being saved as separate files, which are correlated to the image data sets.

The LCD monitor 12 displays information necessary for the operation of the digital camera 1, in addition to the image data sets S0.

The card interface 14 saves the image data sets S0 in the memory card 2 during photography, and reads out the image data sets S0 from the memory card 2 during classification thereof.

The control portion 16 executes the program stored in the memory 15 when a command to classify the image data sets S0 is input by a user via the operating portion 13. Then, the image data sets S0 are classified by referring to the database DB, also stored in the memory 15, with the date data attached to the image data sets S0.

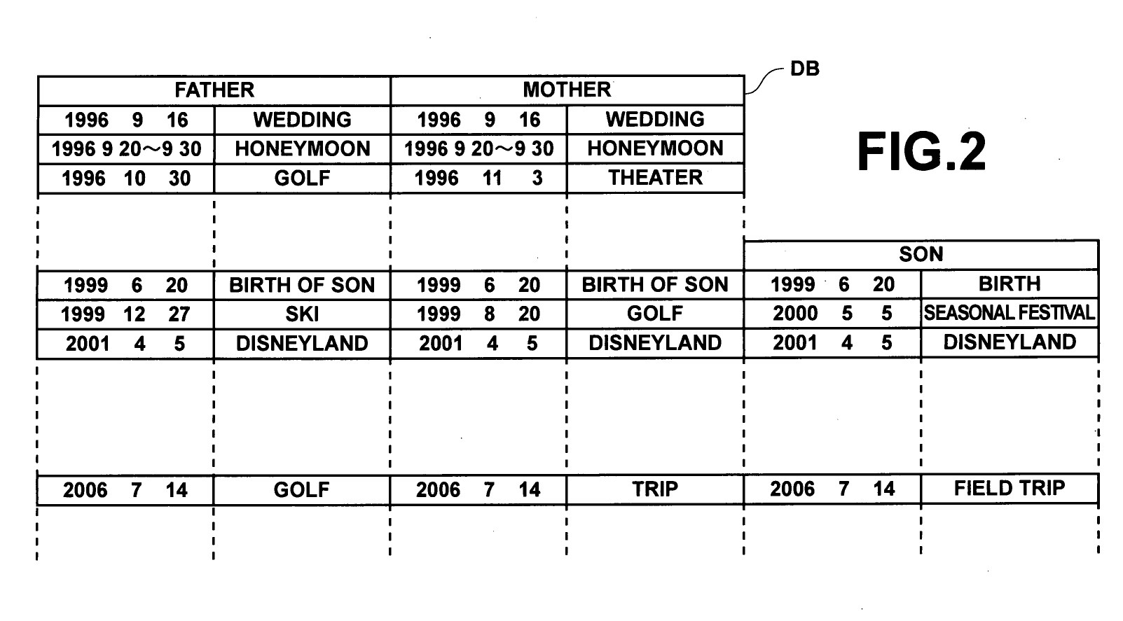

FIG. 2 shows an example of the structure of the database DB stored in the memory 15. As shown in FIG. 2, events related to family members (father, mother, and son) are stored, corresponding to the dates of the events, in the database DB. The events are stored in chronological order, and only events related to the father and mother exist, prior to the birth of their son. In the database DB of FIG. 2, the event “birth of son” is stored, related to the father, the mother, and the son, corresponding to the date of Jun. 20, 1999.

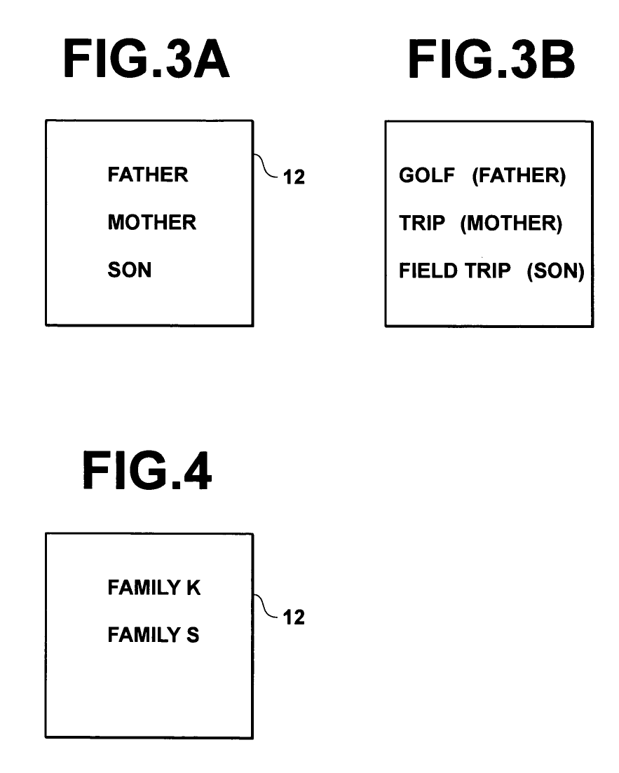

In the case that the date represented by the date data attached to image data sets S0 to be classified is Jun. 20, 1999, the event “birth of son” is commonly related to the father, the mother, and the son in the database DB. Therefore, “Father”, “Mother”, and “Son” are displayed on the LCD monitor 12, as shown in FIG. 3A. The user of the digital camera 1 is prompted to input a command that selects with whose event the image data sets S0 are to be correlated. For example, if the image data sets S0 are being classified by the father, by selecting “Father”, they are correlated with the event related to him.

In the case that the date represented by the date data attached to image data sets S0 to be classified is Jul. 14, 2006 the events “Golf”, “Trip”, and “Field Trip” are related to the father, the mother, and the son, respectively. Therefore, “Golf (Father)”, “Trip (Mother)”, and “Field Trip (Son)” are displayed on the LCD monitor 12 as shown in FIG. 3B. The user of the digital camera 1 is prompted to input a command that selects with which event the image data sets S0 are to be correlated. For example, if the image data sets S0 are being classified by the mother, by selecting “Trip (Mother)”, they are correlated with the event “Trip”, related to her.

Note that a plurality of databases DB are stored in the memory 15. Specifically, a case is assumed in which a family K and a family S share the digital camera 1. In this case, a database for the family K (DBk) and a database for the family S (DBs) are stored in the memory 15, to enable correlation of events and image data sets S0 separately for each family. In the case that a plurality of databases, such as database DBk and database DBs, are stored in the memory 15 in this manner, the names of the databases DBk and DBs are displayed on the LCD monitor 12. The user is prompted to input a command to select the database to be utilized for the classification of image data sets S0. Note that instead of displaying the names of the databases DBk and DBs, the database to be utilized for the classification of image data sets S0 may be selected by directly inputting the name thereof via the operating portion 13.

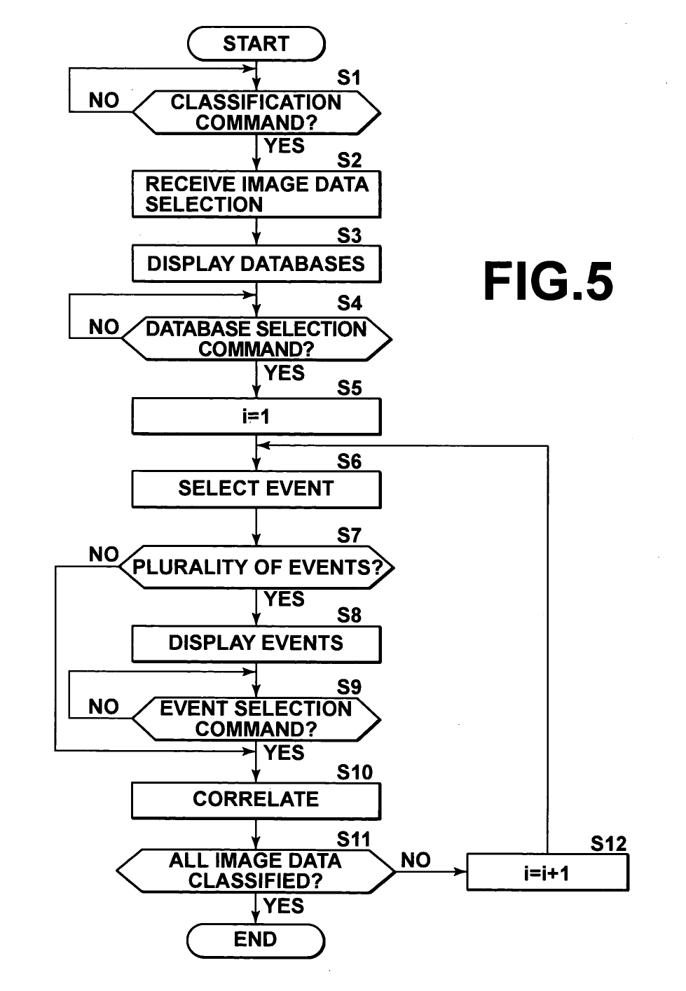

Next, the processes performed in the present embodiment will be described. FIG. 5 is a flow chart illustrating the processes performed in the present embodiment. Note that here, a case is assumed in which a plurality of image data sets S0 have been obtained by photography and stored in the memory card 2. First, the control portion 15 monitors whether the user has input a command to classify the image data sets S0 (Step S1). When the user inputs the command to classify the image data sets S0 (S1=YES), selection of the image data sets to be classified (image data sets SC) is received (Step S2). The selection may be performed by the user inputting the file names of the image data sets SC using the operating portion 13. Alternatively, thumbnail images of the image data sets S0, which are stored in the memory card 2, are displayed on the LCD monitor 12, and the user may select image data sets SC to be classified from among the displayed thumbnail images. Note that here, it is assumed that a plurality of image data sets SCi (i=1˜n) have been selected to be classified.

Thereafter, the names of the plurality of databases DB, which are stored in the memory 15, are displayed on the LCD monitor 12 (Step S3). The control portion 16 initiates monitoring of whether the user has input a command to select a database DB to be utilized for classification (Step S4). When the result of monitoring is affirmative (Step S4=YES), the classification process is initiated.

The image data sets SBi to be classified are sorted in order of their file names, and image data set SB1 (i=1) is set as the first image data set to be classified (Step S5). Then, an event corresponding to the date of photography, represented by the date data attached to the image data set SB1, is selected from the database DB (Step S6). Specifically, the date of photography, represented by the date data, is compared with the dates of the events stored in the database DB, and all of the events that match the date of photography are selected as corresponding events.

Next, the control portion 16 judges whether there are a plurality of corresponding events (Step S7). If a plurality of corresponding events exist (S7=YES), the plurality of corresponding events are displayed on the LCD monitor 12 (Step S8). Specifically, the names of the plurality of selected corresponding events are displayed on the LCD monitor 12, as shown in FIG. 3A and FIG. 3B.

Then, the control portion 16 initiates monitoring of whether the user has input a command to select a corresponding event to be utilized for classification (Step S9). When the result of monitoring is affirmative (S9=YES), the corresponding event for which a selection command has been input is correlated with the image data set SBi (Step S10). Specifically, the selected corresponding event is described in the tag information of the image data set SBi. Thereafter, a judgment is made regarding whether all of the image data sets SBi have been classified (Step S11). If the result of judgment is negative (S11=NO), i is incremented by 1 to change the image data set to be classified to the next image data set SBi+1 (Step S12), and the process returns to step S6. If the judgment in step S11 is affirmative (S11=YES), the process ends.

Note that in the case that the judgment in step S7 is negative (S7=NO), there is only one selected corresponding event. Therefore, the process proceeds to step S10, and the selected corresponding event is correlated with the image data set SBi.

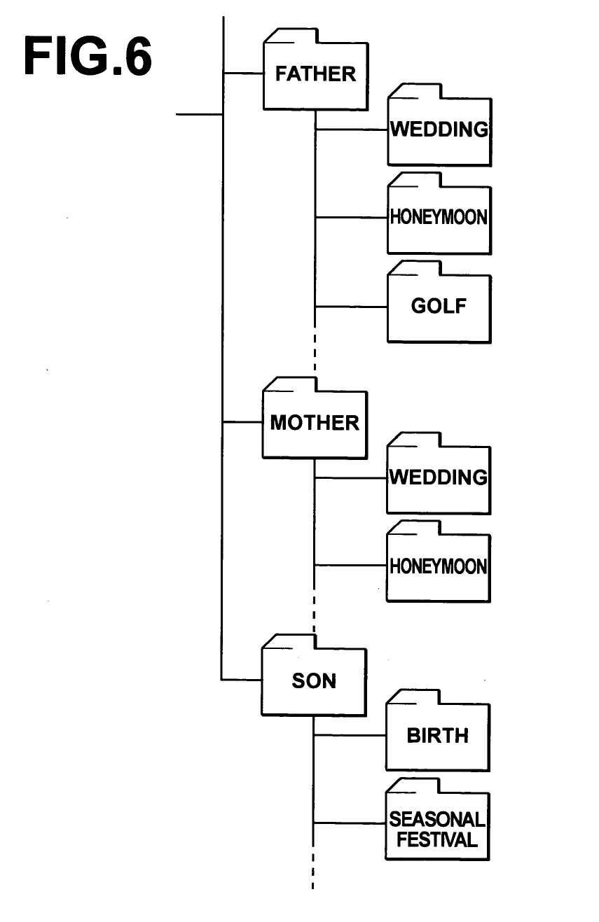

Here, the corresponding event is correlated with the image data sets SBi by describing the corresponding event in the tag information of the image data sets SBi. Alternatively, the corresponding event may be correlated with the image data sets SBi by being saved in folders corresponding to the corresponding events, as shown in FIG. 6.

As described above, in the present embodiment, an event corresponding to the date of photography represented by the date data, attached to image data sets S0, is selected from a database of events, in which events that relate to each of a plurality of people are stored, correlated with dates of the events. Then, the image data sets are correlated with the selected corresponding event. Therefore, image data sets can be correlated to events related to each of the plurality of people who share the digital camera 1. This can be accomplished by creating a database, in which events that relate to each of the plurality of people are stored, correlated with dates of the events. Correlation is performed by referring to the database. Accordingly, even if the digital camera 1 is shared among the plurality of people, image data sets can be classified according to events for each of the plurality of people.

In the case that there are a plurality of databases DB, selection of a single database from among the plurality of databases is received. Then, the corresponding event is selected by referring to the selected database. Thereby, the image data sets S0 can be classified by referring to a database suitable for classification thereof.

In the case that there are a plurality of events, related to the plurality of people, that correspond to the date of photography represented by the date data, the plurality of corresponding events are displayed on the LCD monitor 12. Selection of a single event from among the plurality of displayed events is received. Then, the image data sets S0 are correlated to the selected corresponding event. Thereby, the image data sets S0 can be classified in a manner that reflects the intentions of the user who is classifying the image data sets S0.

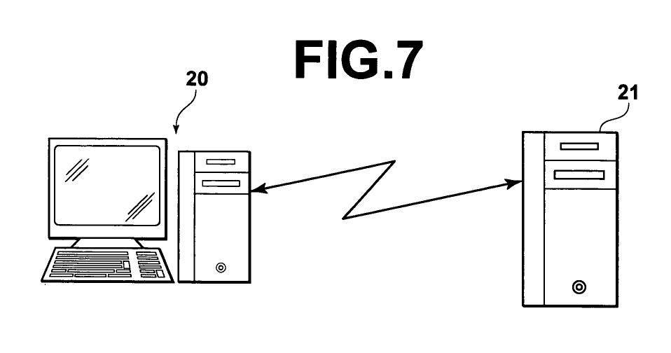

Note that in the embodiment described above, the image data sets S0, which are stored in the memory card 2 of the digital camera 1, are correlated with the events. However, the present invention may be applied to an image storage system as illustrated in FIG. 7, wherein a personal computer 20, which is shared by family members, accesses an image server 21, which stores image data sets S0 of the family, to correlate the image data sets S0 to events. In this case, the image server 21 stores the database DB illustrated in FIG. 2. The image data sets S0 may be classified by a user inputting commands for selection of the database DB to be utilized for classification, as well as for selection of events, from the personal computer 20. The image server 21 then correlates the selected events with the image data sets S0.

What is claimed is:

1. A method for classifying image data sets, to which date data that represents the date of photography are attached, comprising the steps of:
obtaining the date data from the image data sets;
selecting an event corresponding to the date of photography from a database of events, in which events that relate to each of a plurality of people are stored, correlated with dates of the events; and
correlating the image data sets with the corresponding event.

2. A method for classifying image data sets as defined in claim 1, wherein:
the image data sets are correlated with the corresponding event by describing the corresponding event in the tag information of the image data sets.

3. A method for classifying image data sets as defined in claim 1, wherein:
the image data sets are correlated with the corresponding event by saving the image data sets in folders corresponding to the corresponding event.

4. A method for classifying image data sets as defined in claim 1, wherein:
selection of a single database from among a plurality of databases is received in the case that a plurality of databases exist; and
the corresponding event is selected from events stored in the selected database.

5. A method for classifying image data sets as defined in claim 1, wherein:
a plurality of corresponding events are displayed in the case that a plurality of corresponding events, correlated with dates represented by the date data, are related to the plurality of people;
selection of a single corresponding event from among the plurality of corresponding events is received; and
the image data sets are correlated with the selected corresponding event.

6. An image classifying apparatus for classifying image data sets to which date data that represents the date of photography are attached, comprising:
a data obtaining means for obtaining the date data from the image data sets;
a storage means for storing a database of events, in which event that relate to each of a plurality of people are correlated with dates of the events;
a selecting means for selecting an event corresponding to the date of photography from the database, based on the date of photography represented by the date data; and
a correlating means for correlating the image data sets with the corresponding event selected by the selecting means.

7. An image classifying apparatus as defined in claim 6, wherein:
the correlating means correlates the image data sets with the corresponding event by describing the corresponding event in the tag information of the image data sets.

8. An image classifying apparatus as defined in claim 6, wherein:
the correlating means correlates the image data sets with the corresponding event by saving the image data sets in folders corresponding to the corresponding event.

9. An image classifying apparatus as defined in claim 6, further comprising:
a database selecting means for selecting a single database from among a plurality of databases in the case that a plurality of databases exist; wherein
the selecting means selects the corresponding event from among events stored in the selected database.

10. An image classifying apparatus as defined in claim 6, further comprising:
a display means for displaying a plurality of corresponding events in the case that a plurality of corresponding events, correlated with dates represented by the date data, are related to the plurality of people; and
a selection receiving means for receiving selection of a single corresponding event from among the plurality of corresponding events; wherein
the correlating means correlates the image data sets with the selected corresponding event.

11. A program that causes a computer to execute a method for classifying image data sets, to which date data that represents the date of photography are attached, comprising the procedures of:
obtaining the date data from the image data sets;
selecting an event corresponding to the date of photography from a database of events, in which events that relate to each of a plurality of people are stored, correlated with dates of the events; and
correlating the image data sets with the corresponding event.

12. A program as defined in claim 11, wherein:
the procedure for correlating the image data sets with the corresponding event describes the corresponding event in the tag information of the image data sets.

13. A program as defined in claim 11, wherein:
the procedure for correlating the image data sets with the corresponding event saves the image data sets in folders corresponding to the corresponding event.

14. A program as defined in claim 11, further comprising:
a database selecting procedure for selecting a single database from among a plurality of databases in the case that a plurality of databases exist; wherein
the selecting means selects the corresponding event from among events stored in the selected database.

15. A program as defined in claim 11, further comprising:
a display procedure for displaying a plurality of corresponding events in the case that a plurality of corresponding events, correlated with dates represented by the date data, are related to the plurality of people; and
a selection receiving procedure for receiving selection of a single corresponding event from among the plurality of corresponding events; wherein
the procedure for correlating the image data sets with the corresponding event correlates the image data sets with the selected corresponding event.

16. A computer readable recording medium having recorded therein a program that causes a computer to execute a method for classifying image data sets, to which date data that represents the date of photography are attached, the program comprising the procedures of:
obtaining the date data from the image data sets;
selecting an event corresponding to the date of photography from a database of events, in which events that relate to each of a plurality of people are stored, correlated with dates of the events; and
correlating the image data sets with the corresponding event.

17. A recording medium as defined in claim 11, wherein:
the procedure for correlating the image data sets with the corresponding event describes the corresponding event in the tag information of the image data sets.

18. A recording medium as defined in claim 11, wherein:
the procedure for correlating the image data sets with the corresponding event saves the image data sets in folders corresponding to the corresponding event.

19. A recording medium as defined in claim 11, wherein the program recorded therein further comprises:
a database selecting procedure for selecting a single database from among a plurality of databases in the case that a plurality of databases exist; wherein
the selecting means selects the corresponding event from among events stored in the selected database.

20. A recording medium as defined in claim 11, wherein the program recorded therein further comprises:
a display procedure for displaying a plurality of corresponding events in the case that a plurality of corresponding events, correlated with dates represented by the date data, are related to the plurality of people; and
a selection receiving procedure for receiving selection of a single corresponding event from among the plurality of corresponding events; wherein
the procedure for correlating the image data sets with the corresponding event correlates the image data sets with the selected corresponding event.
